(19) United States
(12) Patent Application Publication
(10) Pub. No.: US 2004/0091838 A1
(43) Pub. Date: May 13, 2004

(54) Dental prosthesis with a suction retaining device

(76) Inventor: Ulrich Loertscher, Zurich (CH)

Correspondence Address: Frishauf Holtz Goodman & Chick, 25th Floor, 767 Third Avenue, New York, NY, 10017-2023, US

(21) Appl. No.: 10/468,927

(22) PCT Filed: Mar. 12, 2002
(86) PCT No.: PCT/IB02/00727

(30) Foreign Application Priority Data
Mar. 12, 2001 (CH) 449/01

(51) Int. Cl. A61C 13/24

(52) U.S. Cl. 433/184

(57) ABSTRACT

On a dental prosthesis comprising an anatomically adapted shaped part (1) and teeth (2), here represented for the lower jaw, after its completion several suction holders (5) are mounted in an individually distributed manner. The primary part of a suction holder (5) is a vacuum adhesion plate (6), which adheres on the ridge (3). The plurality of suction holders (5) distributed on the adhering surface result in a comfortable seat and a good adhesive strength.

### CROSS REFERENCE TO RELATED APPLICATIONS

This application claims the priority of Swiss patent application 0449/01, filed Mar. 12, 2001, the disclosure of which is incorporated herein by reference in its entirety.

### TECHNICAL FIELD

The invention concerns a dental prosthesis with suction holders according to the preamble of claim 1 as well as a method for its production according to the preamble of claim 17 or 18 as well as a kit of parts for the production of a dental prosthesis according to the preamble of claim 23.

### BACKGROUND ART

Dental prosthesis with suction holders are for example known from FR 2 641 965, from DE 26 37 994 and from DE 837 292. According to FR 2 641 965 tapes with chambers arranged regularly thereon are used. Since the chamber walls are standing substantially perpendicularly, there results no good sealing and no good adhesion. The arrangement of chambers on a tape fixes to a large extent the position of the chambers in advance and only a complete tape can be positioned. DE 26 37 994 shows a tape solution with chambers with substantially perpendicular walls as well. DE 837 292 also proposes the arrangement of tapes. DE 453 773 shows a special construction of a prosthesis with recesses for two suction cups.

The problem of a well adhering prosthesis is as old as the prosthesis itself. The mere adhesion by saliva rarely results in a satisfying adhesion. The state of the art knows some methods which are supposed to solve the problem in a mechanical or chemical manner.

The proposals which are based on creating a better adhesion by using a vacuum are various. For this purpose there are passive valves built into the shaped part which dispose air cushions that can emerge during the attaching of a prosthesis. Thereby an improved natural adhesion is achieved, but not more. With active valves a vacuum is created by pumping by hand or by a masticatory movement. The problem of these solutions lies in the valve itself which can be plugged by food. However, the bigger problem is to tighten the edge of the prosthesis and keep it tight during the masticatory process. Many times the edges of the prosthesis comprise a complicated structure and the ridge and palatal portions vary from soft to hard. Though, there are proposals with very elastic edge sealings, the fact however that a solution with valve is used nowhere shows that the problems are not solved.

In addition at a vacuum on a to large area there is the danger of an irritation of the salivary glands which are then stimulated to overproduction. This became apparent when at upper jaw prostheses on the palatal plate a big vacuum adhesion plate was attached. There was to much vacuum adhesion on one area. In addition to that the impression of the relatively bulky edge of the plate on the thin skin was to strong, especially since the plate with its original straight starting position was pressed into the palatal curve. This method is not used any more.

Hence, in practice chemical products, adhesive powder and adhesive cremes are used. Both result in a good adhesive strength. However, the use is perceived as unpleasant. The powder is rinsed away in a couple of hours and the taste of the powder itself is disturbing. Concerning these properties the creme is better, but it has to be scratched out of the prosthesis in the evening and it is not easy to apply the creme nicely regularly on the prosthesis, such that possibly nothing swells out of the edges.

All mentioned solutions have one property in common: The prosthesis holds or it doesn't hold. This means that in case of a wrong movement the adhesion is solved instantaneously, without warning, which can become embarrassing in public.

### DISCLOSURE OF INVENTION

It is the object of the invention to achieve a good adhesion of a prosthesis without the above mentioned disadvantages. According to the invention this is achieved by the characterizing features of the independent claims. The prosthesis with teeth fixed to it is manufactured and fitted in the usual way and is on the shaped part or on the adhering surface of the shaped part provided with many small suction holders with vacuum adhesion plates. These are distributed individually and are mounted as single pieces. The suction holders are individual in regard to their position, i.e. arranged depending on the concrete shape of each shaped part of the prosthesis.

In the production process the suited places are chosen individually depending on whether it is possible to mount an individual suction holder; the prerequisite for it is a reasonably flat surface of the shaped part which has a diameter of about 3 mm.

At a preferred alternative of attachment at the suited positions about 30-100 holes are drilled into the shaped part, into which the suction holders are plugged. The preferably very small vacuum adhesion plates with a diameter of less than 8 mm or less than 5 mm or less than 3 mm and preferably about 1,5-2,5 mm can adapt itself optimally to a ridge structure and protrude only little. The bear-on pressure is well distributed and the skin cannot be irritated any more.

The advantage lies in that in a mechanically simple manner and at a low cost a well and secure adhesion is achieved. In addition already existing prosthesis can be upgraded without problem. Older prostheses which do not fit any more (because of shrinking of the ridge) can after a preceding reshaping (adding material underneath) be provided with suction holders.

The kit for production of such prosthesis comprises special blind hole drills or milling cutters and suction holders.

The system also offers a psychological advantage: if for example an upper jaw prosthesis detaches from the fitting, it does not fall down immediately, but first some suction holders detach and others still hold. Hence, there is a warning to reposition the prosthesis by clenching the teeth.

### BRIEF DESCRIPTION OF DRAWINGS

Further embodiments, advantages and applications of the invention will become apparent when consideration is given to the dependent claims and the following description which makes reference to the figures, wherein these figures show:

FIG. 1 a sectional view of a lower jaw prosthesis,

FIG. 2 a view of the lower side of a lower jaw prosthesis with shaped part,

FIG. 3 a view of the lower side of an upper jaw prosthesis with shaped part and palatal plate,

FIG. 4 a sectional view of a suction holder,

FIG. 5 a sectional view of an alternative of the suction holder,

FIG. 6 a sectional view of a further alternative of the suction holder,

FIG. 7 a sectional view of an alternative of a way of attaching the suction holder to the shaped part,

FIG. 8 a sectional view of an alternative of the suction holder build into the shaped part,

FIG. 9 a sectional view of a special bore with a special drill,

FIG. 10 a sectional view of a countersink with a special milling cutter.

### MODES FOR CARRYING OUT THE INVENTION

In the following the object of the invention is explained in more detail referring to the drawings below.

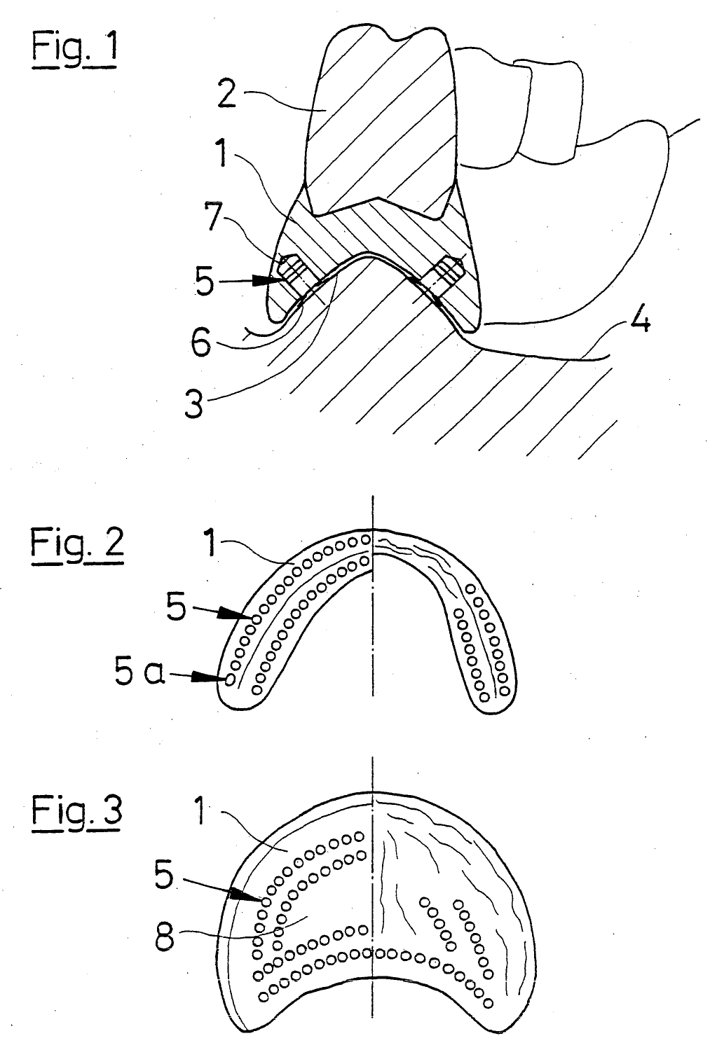

FIG. 1 shows a sectional view of a lower jaw prosthesis consisting of a shaped part 1 and teeth 2. Two rows of suction holders 5 (component indicated with arrow) with vacuum adhesion plates 6 are inserted in bores 7. They adhere on the ridge 3 which the palate 4 connects to.

FIG. 2 shows a view of the lower side of a lower jaw prosthesis with shaped part 1. The view shows the individual form of prostheses in general. The left half represents a broader prosthesis, where without effort two rows of suction holders 5 are placed one-by-one and individually, in the shown example to a large extent regularly. The right half represents a prosthesis with a narrow front part which in addition comprises a strong relief. Here, only in the back suction holders 5 are placed. Placed individually means that the small suction holders are placed one-by-one freely corresponding to the particular shape of the individual prosthesis, where this is permitted by the shape of the shaped part. In this process a plurality of suction holders is placed, preferably more than 10, further preferably more than 20 and further preferably more than 30. The mounting is done by a dental technician based on the given form of the prosthesis. The participation of a dentist is not necessary; the prosthesis is furnished with the suction holders at a dental technician service.

If there is enough space, of course also three rows can be placed. Preferably suction holders 5 with round vacuum adhesion plates 6 of the same diameter are inserted. A combination of different diameters is also feasible, as well as a different shape of the plate. For example an ellipse, as show at the suction holder 5a in FIG. 2. The suction holders can of course, since they are placed one-by-one, also be arranged irregularly.

For an optimum adhesion it is better to place many small suction holder than few bigger ones.

FIG. 3 shows a view of the lower side of an upper jaw prosthesis with shaped part 1 and palatal plate 8. The left half represents a structural favorable situation, at which the individual suction holders 5 can be placed almost arbitrarily. The right half shows a strong irregular structure, less suction holders 5 can be placed.

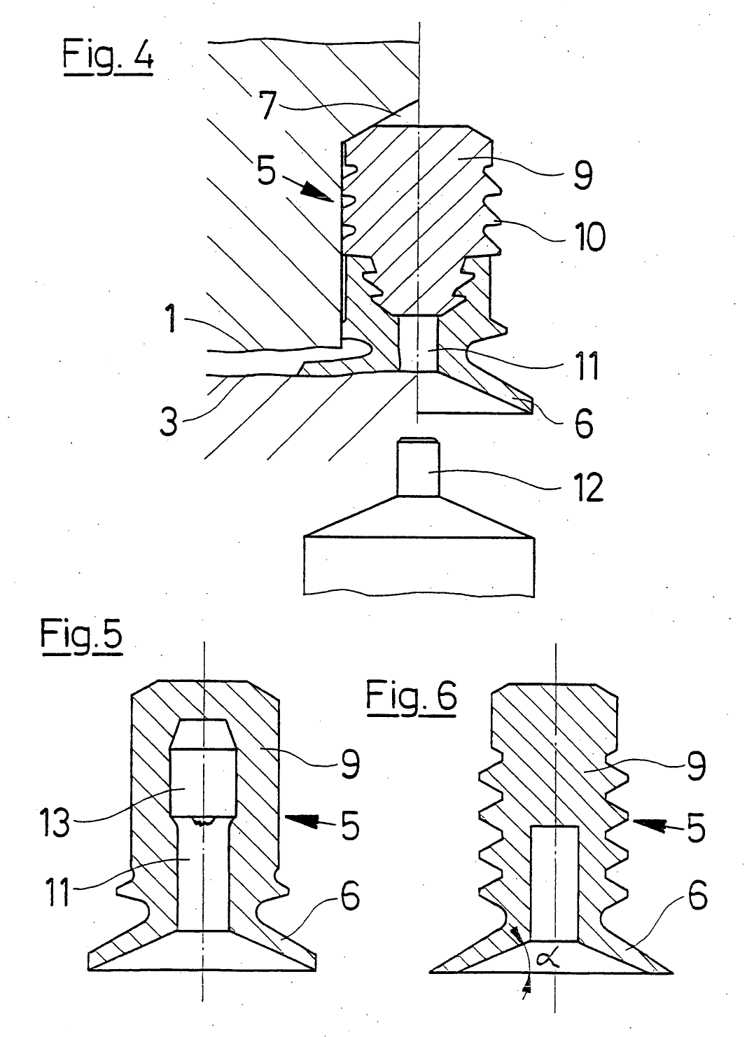

FIG. 4 shows a sectional view of a suction holder 5. At the left half the suction holder 5 is pressed in the shaped part 1 by a bore 7 and the vacuum adhesion plate 6 is in action, i.e. pressed flat onto the ridge 3. The right half shows the suction holder 5 before the mounting. The primary part is the vacuum adhesion plate 6. The diameter of it, the angular dimensions and the hardness of the elastic material can be arbitrary. However, preferred are very small vacuum adhesion plates with a diameter in unspread state of less than 8 mm, preferably less than 6 mm and further preferably less than 3 mm, in particular 1,5-2,5 mm. This allows the individual placing also at small flat surfaces of the prosthesis in large number. A holding body 9 with annular jags 10 is connected to the vacuum adhesion plate 6. The holding body 9 is from harder material than the vacuum adhesion plate. This results in a stronger press fit in the bore 7.

Bores 7 are drilled preferably by hand for the mounting of suction holders 5 in the shaped part 1. In order that the bores 7 always get equally deep, the drill has a stopper. The suction holder 5 is mounted, by being picked up by the mounting mandrel 12 by a recess 11 and being pressed into the bore 7.

FIG. 5 shows a sectional view of an alternative of the suction holder 5. Here the vacuum adhesion plate 6 and the holding body 9 are formed in one piece. A press-fit results by pressing a dowel 13 into the recess 11 after mounting of the suction holder 5.

FIG. 6 shows a sectional view of a further alternative of the suction holder 5. The vacuum adhesion plate 6 and the holding body 9 are formed in one piece here as well. Instead of being press-fit the suction holder 5 can also be held in the bore 7 by glue. Further constructive embodiments based on the principle of a bore 7 are possible.

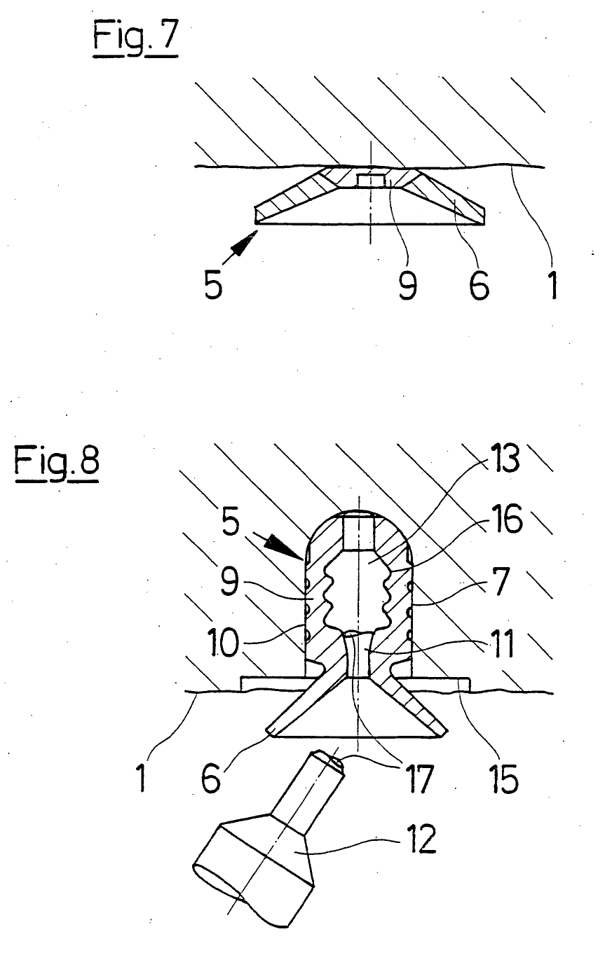

FIG. 7 shows a sectional view of an alternative of a way of mounting the suction holder 5 at the shaped part 1. The vacuum adhesion plate 6 and the holding body 9 are fixedly attached to each other. The attachment of the holding body 9 to the shaped part 1 is preferably done by ultrasonic welding or vibration welding.

FIG. 8 shows a sectional view of an alternative of the suction holder 5 built into the shaped part 1 which holds especially well in the bore 7. The bore 7, which is special here, with countersink 15 is described in more detail at FIGS. 10 and 11.

The suction holder 5 with vacuum adhesion plate 6 and holding body 9 with annular jags 10 is formed in one piece. A dowel 13 comprising annular shapes 16 is pressed in the recess 11 which is here end-to-end. Before the pressing-in, the dowel 13 is connected to the mounting mandrel 12 in one piece. After the pressing-in, the mounting mandrel 12 is broken away by twisting or tilting which results in a breaking point 17.

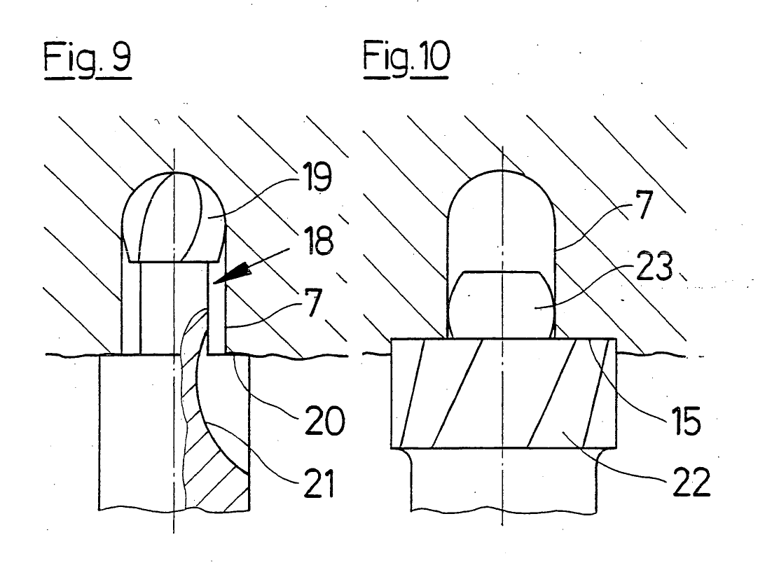

FIG. 9 shows a sectional view of a special bore 7 with a special drill 18. This special drill 18 comprises a round head milling cutter 19 and a stopper 20. The advantage compared to an ordinary drilling lies in that if the special drill 18 is shaken the front part of the bore 7 remains round and accurate to size, while in contrast to this when using an ordinary shaft drill there is the risk of a formation of an elliptic shape. Primarily the bore 7 is drilled by hand, using a wire drill or wire milling cutter. The stopper 20 causes the bore 7 to always have the same depth and the notch 21 allows the milling chips to fall out.

FIG. 10 shows a sectional view of a countersink 15 with a special milling cutter 22. The countersink 15 is usually mill cut by hand after finishing the bore 78. The special milling cutter 22 is a flat head milling cutter with a centering pin 23. The depth of the countersink 15 is determined by estimation or by measuring. It is also possible to design a complicated tool which creates bore 7 and countersink 15 together. The countersink 15 causes the gap between shaped part 1 and ridge 3 (FIGS. 1 and 4) to get smaller, since the actively flattened vacuum adhesion plate 6 lies partially in the countersink 15.

The term “suction holder” in this document denotes a substantially elastic element which is attached in or at the substantially hard shaped part 1. A simple recess in the shaped part 1 is therefore not covered by the denotation “suction holder” in terms of this document. Recesses in the shaped part 1, which for example are connected by a channel with further elements such as e.g. pumps or valves are not covered by the term “suction holder” in the meaning of this document as well. Suction holder is understood to be in particular a shape corresponding to that of the classic suction cap or vacuum adhesion plate 6, as shown in the figures, at which the walls of the suction cap or the walls of the plate are in an angle α of less than 90° in respect to the horizontal, preferably also less than 45°, such as it is indicated in FIG. 6. The suction cups have this inclination of the wall already in the undeformed relaxed state; in this way a defined deformation with a good adaptation and a correspondingly long lasting vacuum effect is achieved when putting on the prosthesis.

At new dental prostheses the production is performed by the dental technician arranging the suction holders in blind holes at suited flat positions of the prosthesis. At old prostheses already being used the shaped part is worked on beforehand. The production is facilitated by a kit of materials which comprises the suction holders and matched to their mounting diameter and plate diameter drills, milling cutters, countersink tools and mounting tools.

1. Dental prosthesis comprising an anatomically adapted shaped part (1) and teeth (2) arranged on the shaped part (1), wherein several suction holders (5) are arranged at the shaped part (1), characterized in that the suction holders (5) are placed one-by-one and individually.

2. Dental prosthesis according to claim 1, characterized in that the suction holders comprise vacuum adhesion plates (6) with in the undeformed state inclined walls.

3. Dental prosthesis according to claim 1 or 2, characterized in that each suction holder (5) comprises a vacuum adhesion plate (6) and a holding body (9), wherein the holding body (9) is arranged in a bore (76) of the shaped part (1).

4. Dental prosthesis according to claim 2 or 3, characterized in that a holding body (9) connects to the vacuum adhesion plate (6)., which is harder than the vacuum adhesion plate (6).

5. Dental prosthesis according to claim 3 or 4, characterized in that the vacuum adhesion plate (6) and the holding body (9) are one piece.

6. Dental prosthesis according to claims 1 to 5, characterized in that each suction holder comprises a recess (11), for the connection to a mounting tool (12).

7. Dental prosthesis according to one of the claims 3 to 5, characterized in that the holding body (9) is arranged by a press-fit in the bore (7).

8. Dental prosthesis according to any of the claims 3 to 5, characterized in that the holding body (9) is arranged by glue in the bore (7).

9. Dental prosthesis according to any of the claims 3 to. 5, characterized in that the holding body (9) is arranged by dowel (13) in the bore (7).

10. Dental prosthesis according to claim 1 or 2, characterized in that the holding body (9) is welded to the shaped part (1).

11. Dental prosthesis according to any of the claims 1 to 10, characterized in that the shaped part (1) is designed for attaching it onto the ridge (3) of a lower jaw as a u-shape.

12. Dental prosthesis according to any of the claims 1 to 11, characterized in that it has at least two rows of suction holders (5).

13. Dental prosthesis according to claim 9, characterized in that the dowel (13) is provided with annular shapes (16).

14. Dental prosthesis according to claim 9 or 13, characterized in that the dowel (13) and a mounting mandrel (12) are formed in one piece and that these can be disconnected using a breaking point (17).

15. Dental prosthesis according to claim 3 characterized in that the bore (7) is provided with a countersink (15).

16. Dental prosthesis according to any of the claims 1 to 15, characterized in that it comprises at least ten suction holders (5), preferably more than 20 or more than 30 suction holders, and that the diameters of the vacuum adhesion plates (6) of these suction holders (5) are in particular smaller than 8 mm, preferably smaller than 5 mm and in particular smaller than 3 mm.

17. Method for producing a dental prosthesis according to claim 1, characterized in that first the shaped part (1) is created and then the suction holders (5) are arranged individually at the shaped part (1).

18. Method for producing a dental prosthesis according to claim 1, characterized in that at an older dental prosthesis the shaped part (1) is first reshaped and then the suction holders (5) are arranged individually.

19. Method according to claim 17 or 18, characterized in that the bore (7) is drilled using a special drill (18) and that this special drill comprises a round head milling cutter (19) and a stopper (20).

20. Method according to claim 19, characterized in that the special drill (18) comprises at least one notch (21).

21. Method according to claim 17 or 18, characterized in that the countersink is milled using a special milling cutter (22) which is designed as flat head milling cutter and which comprises a centering pin (23).

22. Method according to claim 21, characterized in that the special milling cutter (22) is designed as rounded head milling cutter.

23. Kit of materials for the production of dental prostheses according to any of the claims 1 to 16, characterized by blind hole drills or blind hole milling cutters and a plurality of suction holders, wherein the dimensions of drills, milling cutters and suction holders are adjusted to each other.

24. Kit of materials according to claim 23, characterized in that the suction holders are designed according to claims 2 to 6.

25. Kit of materials according to claim 23 or 24, characterized in that the blind hole drill or the blind hole milling cutter is designed according to one of the claims 19 to 22.

26. Kit of materials according to any of the claims 23 to 25, characterized in that it comprises a mounting tool for the suction holders.

27. Kit of materials according to any of the claims 23 to 26, characterized in that it comprises dowels adapted to the suction holders, in particular dowels comprising a dowel part which is detachable from a mounting part.

28. Kit of materials according to any of the claims 23 to 27, characterized in that it comprises a countersink tool adapted to the diameter of the plates and the mounting depth of the suction holders.
